(19) United States
(12) Patent Application Publication
(10) Pub. No.: US 2008/0100597 A1
(43) Pub. Date: May 1, 2008

(54) Method and apparatus to improve playability in overscan areas of a TV display

(75) Inventor: Ronald Quan, Cupertino, CA (US)

Correspondence Address: MORRISON & FOERSTER LLP, 755 PAGE MILL RD, PALO ALTO, CA, 94304-1018, US

(73) Assignee: Macrovision Corporation, Santa Clara, CA (US)

(21) Appl. No.: 11/586,988

(22) Filed: Oct. 25, 2006

(51) Int. Cl. G09G 5/00

(52) U.S. Cl. 345/204

(57) ABSTRACT

A television (TV) monitor or receiver normally displays only the active portion of a video signal, and generally the HBI (horizontal blanking interval) and/or the VBI (vertical blanking interval) are not displayed. In some TV displays however, there is provision to display at least a portion of a blanking interval (overscan area). In some displays (such as monitors for professional use) the VBI is displayed as a way to allow the user to monitor test, command, and/or reference signals. If there are added pulses such as the well known copy protection signals present in blanking intervals of the video signal that cause a horizontal (or vertical) timing or recovery circuit to result in erroneous timing, then viewing is impaired of at least one blanking interval for the TV display. For example, if added copy protection pulses in the VBI region cause the horizontal phase lock loop circuit in a TV display to cause a mistiming, then viewing of signals in the VBI (overscan area) will be impaired. Such signals may include test signals and/or sync signals. A method and apparatus disclosed here improve or correct timing in TV display circuits to allow better viewing of the blanking intervals. One such method is to reposition and/or to remove or modify at least one added or other pulse in the VBI and/or HBI.

### FIELD OF THE INVENTION

This disclosure relates to video and television and more specifically to video/television displays such as TV (television) sets and monitors.

### BACKGROUND

This disclosure relates to the display of a non-active (overscan) video portion of a TV signal. TV displays sometimes provide an H (horizontal) and/or V (vertical) scan delay function, which allows a user to view certain TV signals normally not seen (since they are in the overscan area of the TV screen). These signals may include test, timing, time code, teletext, CGMS, and/or closed caption signals. In some cases, added pulses will cause horizontal scan circuits in TV displays (such as TV monitors or TV sets), including phase lock loop circuits, to generate time-base errors that cause a distortion in displaying signals in the VBI (vertical blanking interval) or its vicinity in an overscan area.

Such added pulses may include certain negative going pulses that cause a normally periodic output from a horizontal timing circuit to result in non-periodic pulses or a phase and/or frequency error in the VBI or in an overscan area.

In the past, pre or post equalizing sync (synchronization) pulses were supposed to keep the TV display horizontal oscillator circuit in phase. But when examined carefully with a horizontal timing circuit set for a fast AFC (automatic frequency control) response, the added pulses in the middle of a TV (video) scan line actually cause some small timing errors during the VBI in the horizontal phase lock loop circuit. Also, the narrower width (as compared to a horizontal sync pulse) of the pre or post equalizing pulses can contribute to a phase detector error during the VBI in the horizontal frequency phase lock loop circuit. In another look at vertical sync pulses, these pulses are wider than horizontal sync pulses, but are serrated in an attempt to keep the horizontal frequency phase lock loop in synchronization. But in practice, the broad vertical sync pulses also contribute to timing errors during the VBI in the AFC loop for a horizontal oscillator circuit.

To illustrate this technical problem, in U.S. Pat. No. 5,481,608 to Wijnen, certain negative pulses are inserted near the VBI (in an overscan area) for copy protection purposes, which thereby has non-standard pulse width or position. As a result, a horizontal oscillator circuit for a TV display playing such a signal in an overscan area may be pulled off its nominal phase, which can undesirably cause a shifted look in an horizontally and/or vertically delay scan display. In yet other modifications to a video signal, added negative going pulses in the HBI near or in the VBI also contribute to an erroneous phase shift during an overscan interval in a horizontal frequency phase lock loop. Moreover, certain “pseudo-sync” pulses added to a TV signal for copy protection purposes may cause the phase detector in such a horizontal timing circuit in a TV display to produce distorted scans in a portion of the VBI area, but these pseudo sync or negative going pulses that reside in an overscan area (or positive going pulses in an overscan area) do not produce distortion when viewed normally on a conventional display (e.g., a display without an H or V delay function such as a consumer TV set).

### SUMMARY

A goal here is to provide for better viewability on a TV display of a blanking interval or overscan portion of the video signal, for example, better viewability for H sync and/or color burst envelopes in particular or selected TV scan lines. Also, if there is a signal present in selected TV scan lines in the HBI portion, it is a goal to increase viewability of same by modifying the video signal. The better viewability may include reducing a darkening effect of an overscan portion of the television display, and/or the reduction or elimination of geometric or position errors on the display during an HBI portion and/or a VBI portion and/or during the vicinity of the HBI and/or VBI in an overscan area. “Television display” includes here television receiver, television monitor, video monitor, cross pulse monitor, and computer display, which can display an overscan area, such as a display with H and or V delay. When a standard TV display or set is viewed normally (e.g., without the H and or V delay function), the overscan interval or area is not seen or displayed. Thus, a small amount of the active video line usually resides in an overscan area or interval in standard displays; and these small intervals or areas of the active portion of the video signal will be cropped off via the standard display or in other words not seen by the user.

Yet another goal is to reduce phase errors in a TV display horizontal timing circuit during a TV blanking interval. This blanking interval may include the HBI, e.g., viewing color burst in the HBI by modifying an AGC (added positive going) pulse in or near the HBI and/or VBI, which is in an overscan area. In certain test conditions for an industry standard video copy protection signal, the number of pseudo-sync pulses are changed from one video scan line to another video scan line. Also, the pseudo-sync pulses may be position and/or pulse-width modulated. Pulses like these may be inserted or added in the VBI or its vicinity in an overscan area, which would then cause a display with a fast responding AFC horizontal phase lock loop oscillator to display a geometrical distortion in a VBI or its vicinity in an overscan area.

U.S. Pat. No. 6,836,549 describes various methods and apparatuses to modulate pseudo-sync (or normal sync) pulses and/or modulate AGC pulses. The modulation may include position and or pulse-width and/or amplitude modulation. The modulation (which may include amplitude or position or pulse duration) may be applied to one or more pulses at a time. With modulation in position and/or duration of negative going pulses within a VBI location and/or a VBI vicinity in an overscan area, the phase detector or a phase lock loop may generate dynamic or time varying error signals to the horizontal voltage controlled oscillator during an overscan interval. It is another goal of this disclosure to at least reduce the amount of time varying effect during an overscan interval on a phase lock loop circuit's phase detector or oscillator stability.

Furthermore, in pending U.S. patent application Ser. No. 11/123,826, Method and Apparatus for Modifying a Subsequently Generated Control Command in a Content Control System (incorporated herein by reference in its entirety), certain content control or copy protection signals may be rearranged in a VBI area, which may cause additional geometric distortion when displayed in an overscan area. One goal of the present disclosure is to allow for less display of such geometric distortion in an overscan area when content control or copy protection signals are manipulated to change a command in a content control system.

In another embodiment, a color burst phase modification on selected TV lines may be used to identify certain types of color processing systems when viewed in the overscan area. A prior art colorstripe signal or a new color stripe signal may be used for the identifying the color processing system. And a new color stripe signal that has at least part of a cycle of incorrect phase added to TV lines may increase effectiveness, which may be used for copy protection and or be used for identification purposes as described.

### BRIEF DESCRIPTION OF THE DRAWINGS

FIG. 1A shows a block diagram of a typical prior art horizontal timing circuit commonly used in TV displays.

FIG. 1B shows a block diagram of a typical prior art clamping circuit used in TV displays.

FIG. 1C shows waveforms for a horizontal frequency phase lock loop's response to a non-standard horizontal sync pulse added after a normal horizontal sync signal.

FIG. 1D shows an example a waveform of added negative pulses changing in position and/or duration (e.g., which can be within a TV line, or from one TV line to another TV line).

FIG. 1E shows waveforms illustrating an effect of more than one pulse added to a portion of a video signal.

FIG. 2 shows an illustration of a video display with a delayed vertical and horizontal scan.

FIG. 3 shows an illustration of a video display with a delayed vertical and horizontal scan where a geometric distortion in an overscan area occurs in the display.

FIG. 4A shows a block diagram of a system whereby a video signal has added waveforms or signals in at least a portion of the VBI and/or in at least in an overscan interval of the video signal.

FIG. 4B shows a picture of a TV display with an H-V delay, displaying the horizontal and vertical interval in response to a signal similar to that of FIG. 4A.

FIG. 5A shows a general embodiment of the present apparatus; FIGS. 5B1 to 5B6 show variants thereof.

FIGS. 6A and 6B show a variation of the color burst signal where there is at least one phase switch point.

FIGS. 7A, 7C, and 7D show copy protection or content control waveforms with FIG. 7C and or 7D showing a waveform that is less immune to bandpass and/or comb filtering. FIG. 7B shows a normal color burst waveform.

FIG. 8 shows a block diagram of an HBI modifier.

FIG. 9 shows a block diagram of an apparatus for inserting or adding or providing a color sub-carrier signal to a portion of a video signal.

FIGS. 10A, 10B show on a display a phase modification in at least one vertical blanking interval that allows for identifying a type of color processing circuit of a TV set.

### DETAILED DESCRIPTION

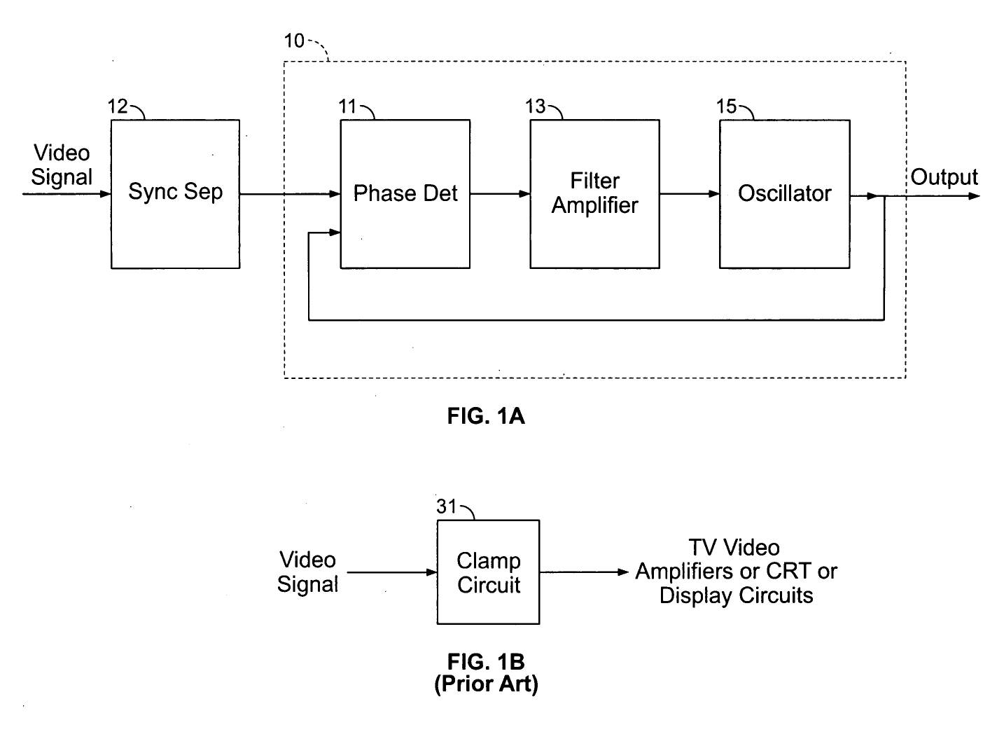

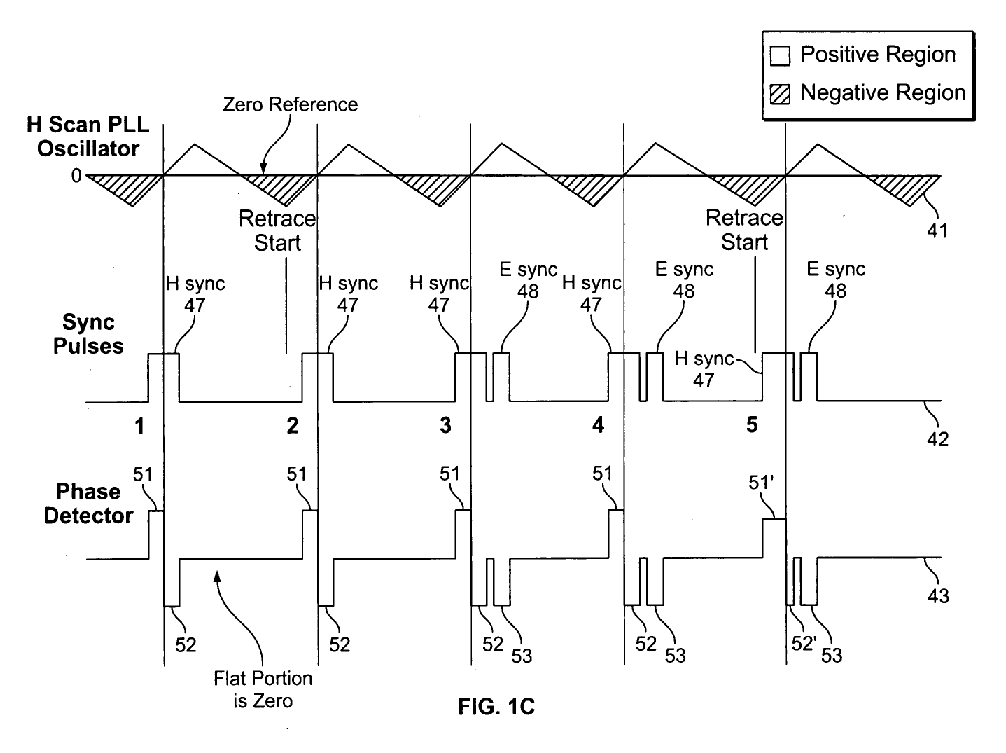

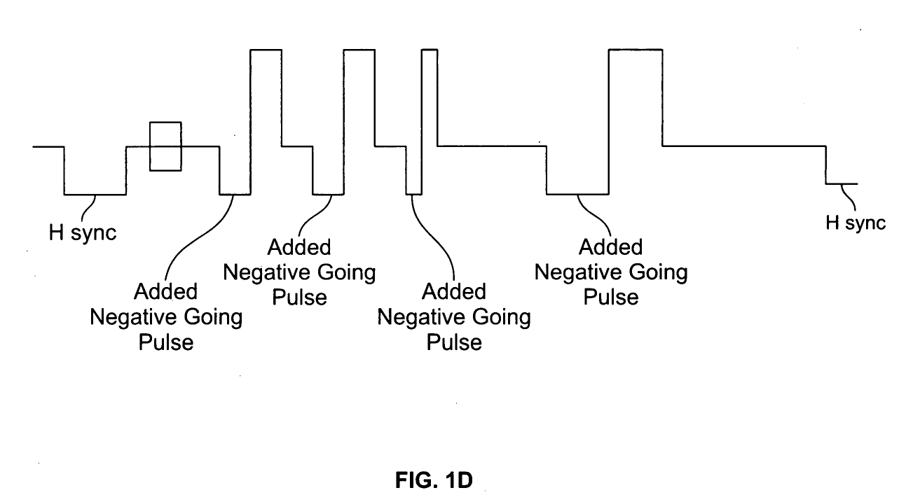

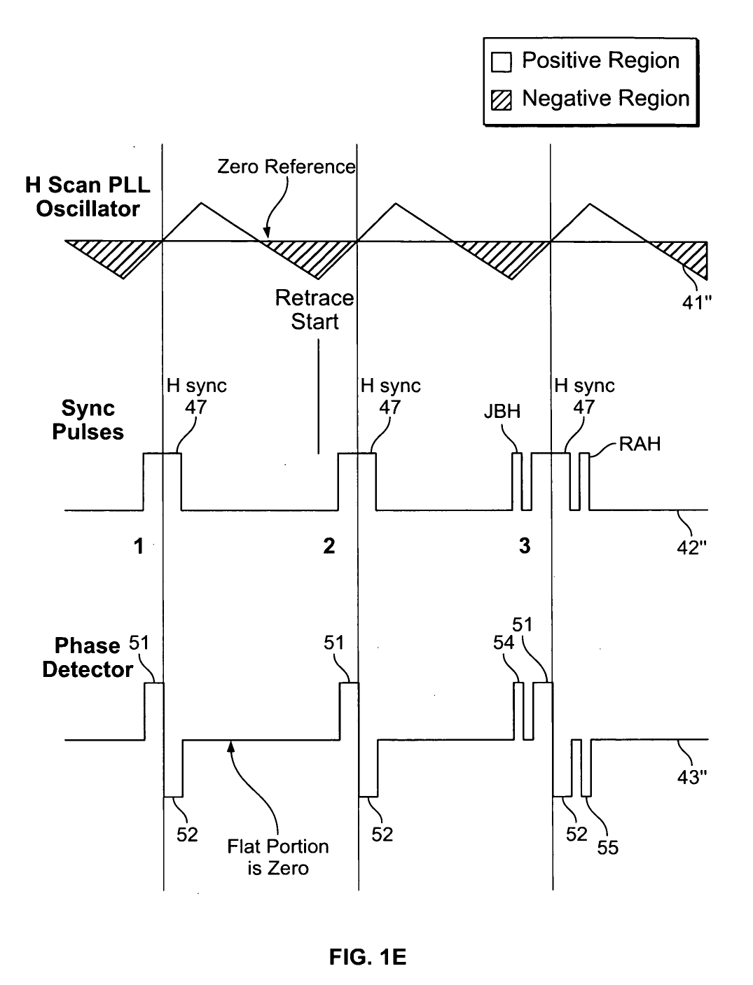

FIG. 1A shows a block diagram of a (prior art) horizontal frequency phase lock loop circuit 10 of the type conventional in TV displays, which receives video signal pulses from the TV display's sync separator 12 to couple same to a first input terminal of a phase detector 11 of circuit 10. The output signal of the phase detector 11 is coupled to a filter and/or amplifier 13 and then supplied to a variable frequency oscillator (or voltage controlled oscillator) 15. The output signal of the oscillator 15 is then coupled to a second input terminal of the phase detector 11. Conventionally, the filter 13 is set to a long time constant, and/or the variable frequency oscillator 15 has a very limited frequency deviation range. The reason is that prior to the popularity of the home VCR (video cassette recorder), the signals coupled to a TV display horizontal phase lock loop circuit 10 were very stable time base-wise and did not deviate much in frequency. However, the introduction of home video cassette recorders caused the makers of TV horizontal phase lock loop circuits to redesign the filter 13 and/or the frequency deviation range of the variable frequency oscillator 15. Thus, added negative going pulses that are separated or sensed by the sync separator 12 may cause such newer type horizontal phase lock loops to generate a scan error more noticeable in an overscan area than that of the older horizontal phase lock loop circuits. The horizontal phase lock loop circuit 10 of FIG. 1A may be used in a TV display to generate waveforms for horizontal scanning circuits.

FIG. 1B shows a block diagram of a conventional (prior art) clamp circuit 31 used in TV displays to establish a blanking or black level amplitude reference level for the displayed picture. Clamp circuit 31 generally derives a sampling signal from the sync separator or horizontal phase lock loop circuit to generate a pulse coincident to a portion of the HBI's back porch. Depending on how fast clamp circuit 31 reacts determines the ability to reference the blanking or black level within a given time interval. Generally, clamp circuit 31 reacts in a somewhat slow manner so as not to react to noise in the TV signal back porch region (following the H sync pulse). With some added pulses in a back porch region of the overscan area, the clamp circuit can produce a luminance error when viewed in the overscan area (e.g., in a TV set with an H or V delay function) while showing no display errors for a normally viewed standard TV set.

FIG. 1C shows a series of waveforms that illustrate an effect of an extra or added (e.g. pseudo-sync) negative going pulse following a conventional horizontal sync pulse. Waveform 41 denotes a horizontal scanning waveform such as a sawtooth signal having positive and negative regions used in horizontal deflection circuits. The positive and negative regions of the sawtooth wave form are indicated by shading. Waveform 41 may be sourced from a horizontal frequency phase lock loop circuit (PLL) as described above or a voltage controlled oscillator. Waveform 42 denotes an output signal from a sync separator circuit (which for example, the sync separator slices at a level below a blanking level for a video signal while providing inversion in polarity at the sync separator's output). As shown in waveform 42, there are present horizontal sync pulses (H sync) 47 and an extra sync pulse (E sync) 48. Waveform 43 denotes an output signal of a typical phase detector, which has an input from the sync separator and from the horizontal frequency voltage controlled oscillator. Pulse 51 denotes a positive going pulse when the sync separator output is coincident with the voltage controlled oscillator's waveform in the negative voltage region, whereas pulse 52 is a negative going pulse coincident when the sync separator output signal is coincident with the waveform 41 in the positive voltage region.

Because the PLL is a feed back circuit, an equilibrium is established when the areas of pulses 51 and 52 average to zero. As seen in time periods 1 and 2 of FIG. 1C, the retrace start time is 1 time unit before a horizontal sync pulse 47, and the average value of pulses 51 and 52 is zero. In time periods 3 and 4, an extra negative going pulse 48 such as a pseudo-sync pulse trails a (normal) horizontal sync pulse. The phase detector waveform 43 denotes an extra negative going pulse 53 (e.g., due to pulse 48). This negative pulse 53 then causes a net negative average value to the output from the phase detector, and the voltage controlled oscillator will have to change its phase to establish an average zero value from the phase detector. As the PLL eventually locks up or comes to equilibrium, as shown in time period 5, pulse 51 is widened to a new pulse 51′, and pulse 52 is shortened to a new pulse 52′ while pulse 53 remains the same at the phase detector output.

As seen in time period 5, waveform 43 has an average value of zero via summing the areas of pulses 51′, 52′ and 53. In time period 5, waveform 41 shows that the sawtooth signal advanced one half a unit square to establish an equilibrium condition for the phase detector. Thus an extra negative going pulse as illustrated in FIG. 1C shows that the scanning waveform has shifted in phase (e.g., shifted to an advanced position or phase).

FIG. 1D shows added negative going pulses to that would occur in one or more TV lines in the vertical blanking interval or its vicinity in an overscan area. The added negative going pulses may include pseudo-sync pulses, such as pseudo-sync pulses that may vary in width and or position within a TV line or within a series of TV lines. Any of these added negative going pulses may cause an erroneous or distorted display in a delayed H or V television monitor for an overscan area. As seen in FIG. 1C, adding just one pulse such as E sync 48 will cause an erroneous retrace start point for the horizontal phase lock loop oscillator. Moreover, a plurality of added pulses such as those illustrated in FIG. 1D will cause, in general, even more of a shift in the retrace start time in an overscan area (e.g., as opposed to adding just one pulse as illustrated in E sync pulse 48).

FIG. 1E shows an example on how to compensate or (to at least partially offset) a scan error or (geometric) distortion for a television display with a delayed H or V function. In one example, FIG. 1E shows how two pulses (e.g., JBH, Just Before Horizontal sync and RAH, Right After Horizontal sync) can balance or substantially reduce skewing of the timing of the horizontal oscillator, which would otherwise result in a (noticeable) picture shift for a display in an overscan area.

As illustrated in FIG. 1E, in parts 1 and 2, a sawtooth waveform 41″ coupled to a phase detector of a horizontal phase lock loop oscillator is shown. In the middle section, the “normal” horizontal sync (H sync) is denoted by a positive going pulse 47, derived from a sync separator circuit (not shown.) In the bottom section, the output of the phase detector as shown has a total duration of positive and negative going pulses, the width of the horizontal pulse. In parts 1 and 2 of FIG. 1E, one half of the phase detector output is in the positive going direction 51 and the other half of the phase detector output is in the negative going direction 52. The top waveform (sawtooth signal) determines the polarity of the phase detector. For example, if the H sync is coincident with the sawtooth waveform's positive cycle (positive area), the phase detector will output a negative going pulse 52. If the H sync pulse is coincident with the sawtooth waveform during its negative cycle (negative area), then the phase detector will output a positive pulse 51.

Because the H sync pulse in parts 1 and 2 of FIG. 1E is coincident with the sawtooth waveform in positive and negative cycles, the phase detector outputs positive and negative going pulses 51, 52, which average to zero. In this example, an average of zero yields a “centered” picture. In panel 3 of FIG. 1E a way is shown of adding extra signals (e.g., JBH and RAH 42″) to the video signal in order to substantially yield a “centered” picture, or to have the phase detector average out to zero (e.g., in waveform 43″, the combined areas of pulses 54 via JBH, 51 and 52 via H sync 47, and 55 via RAH, should average to about zero), while allowing about zero or negligible scan offset to occur. So, if an extra sync pulse is added just before a horizontal sync pulse JBH, then another pulse right after the horizontal sync pulse RAH, must be added (or vice versa) to reduce or to eliminate skewing for example. For example, preferably, the pulsewidth of JBH and RAH is essentially/substantially the same for negligible offset in the oscillator. Also, the number of pulses before and after should preferably have about the same total or cumulative duration so as to balance the phase detector output to zero with reduced or negligible scan offset. For example, as long as the total duration of one or more pulses prior to the H sync is substantially equal to the total duration of one more pulses after the H sync, then a reduction in scan offset or skewing occurs. The relative positions of pulses (e.g., JBH and/or RAH) may be moved around as long as each does not move out of bounds of their respective negative and positive areas as seen in waveform 41″.

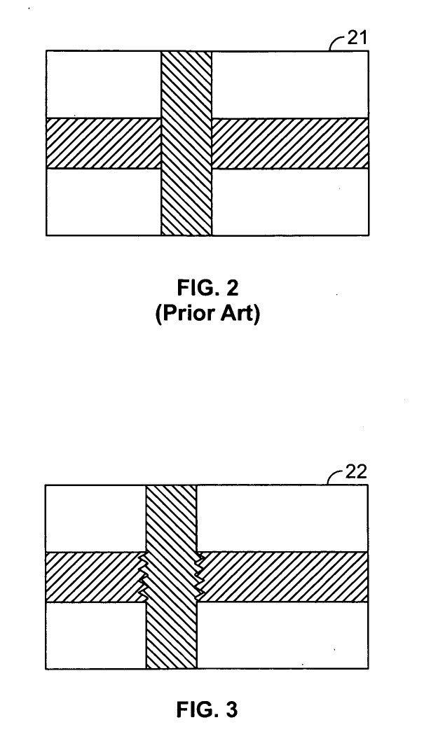

FIG. 2 (prior art) shows a TV display (such as a professional type TV monitor) with a conventional H-V (e.g., cross pulse) delay feature so the blanking intervals are displayed in the center of the screen. Here a normal video signal has its vertical and/or horizontal blanking interval (overscan area) fully displayed. (Note that a typical consumer TV set does not display the vertical and/or horizontal blanking intervals at all.) FIG. 3 shows an illustration of a TV displaying an overscan area such as a TV monitor with an H-V delay feature that has a video signal with added negative pulses in at least a portion of an overscan area or in at least a portion of the vertical blanking interval (VBI). Here, as illustrated, instead of a straight edged display in the VBI, the display is undesirably nonlinear or scrambled looking or geometrically distorted in an overscan area compared to FIG. 2. Thus modifying a video signal (which may include at least one copy protection signal) by adding/inserting one or more negative going signals (or pulses) prior to and or after at least one horizontal pulse, reduces (e.g., geometric) distortion as displayed in an overscan area, such as displayed in a blanking interval. This modification may offset or reduce phase errors during an overscan interval in a phase lock loop circuit or timing circuit, or the modification may reduce a phase error signal during the VBI or overscan area from a phase detector. It should be noted that when viewing normally with a standard display (e.g., with a consumer TV set that does not use or has an H and/or V delay function), negative going pulses and or positive going pulses in an overscan area do not cause a distortion on the display.

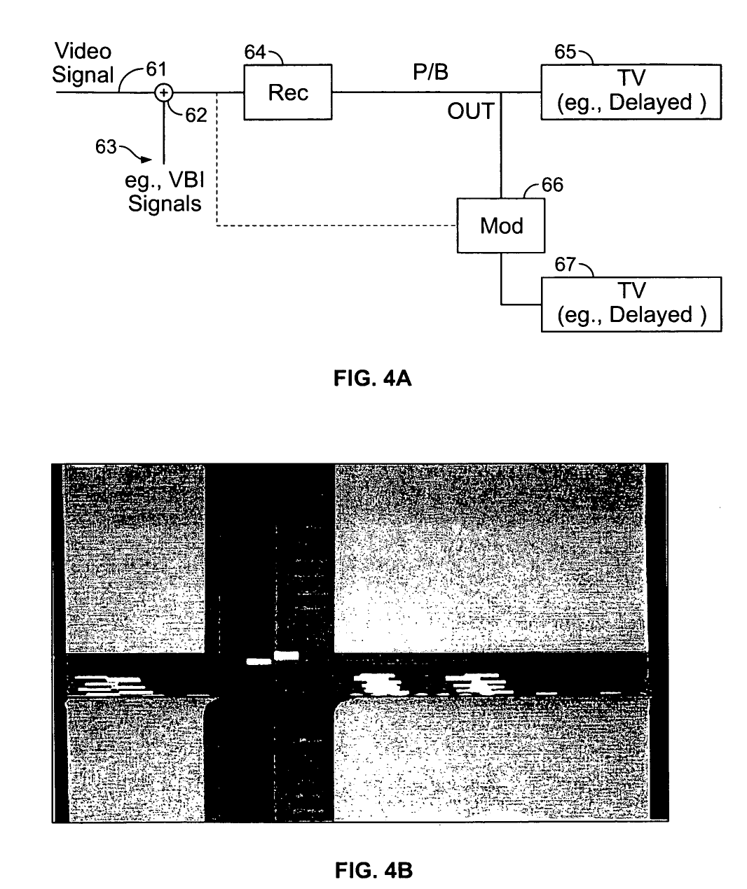

FIG. 4A shows a video signal applied at terminal 61 (e.g., a program video source) along with a signal from source 63 (e.g., copy protection signal(s) provided in an overscan interval or area) combined or added or inserted via combining circuit 62 to provide a waveform in a portion of an overscan area of a display. The output signal of circuit 62 is then coupled to a video recorder (e.g. VCR) 64. The output signal “out” of recorder 64 then plays back the video signal along with the overscan waveform. Because video recorder 64 may introduce some time base errors such as those usually found in VCRs, a TV display connected to play the output signal from video recorder 64 generally has a horizontal scan circuit that reacts quickly to such time base errors (e.g., speed variation of a playback device such as recorder 64), which displays no distortion on a standard TV display when view normally or when viewed without an H and or V delay function. Thus the added waveform may be construed as a time base error since at least one negative going pulse is out of place of a horizontal sync pulse. Thus a TV display 65 with such an H-V delay will exhibit a geometric distortion or tearing in an overscan region, as shown in FIG. 4B. In particular, the geometric distortion is generally displayed in the VBI if the added waveform is in a VBI region and/or its vicinity in an overscan area. However if the output signal of recorder 64 is coupled to a modifier circuit 66, which alters the video signal and/or waveform, TV display 67 also has an H-V delay, and thereby will exhibit reduced geometric distortion in an overscan area. Also as shown by the dashed line in FIG. 4A, a video source that contains signals in blanking or overscan intervals, such as copy protection signals, may be coupled to the modifier 66. The output of modifier 66 may then be connected to a TV display 67, which shows or displays reduced or eliminated distortion in an overscan area.

In regard to FIG. 4A, the waveform generated by source 63 may cause TV display 65 to exhibit any combination of luminance and/or chrominance errors and/or geometric distortions in the VBI or in an overscan area. The luminance and/or chrominance errors would show up as, for example, darkening or lightening in at least a portion of one or more blanking intervals in an overscan area as displayed by TV display 65. Thus modifier circuit 66 may reduce any combination of luminance and/or chrominance and/or geometric error/distortion on a monitor that displays a portion of an overscan area or blanking interval. Note that a modifier such as circuit or apparatus 66 may be coupled between a video source (e.g., signals 61+63, or a video source that may contain copy protection signals in an overscan area or interval) that provides signals in a portion of the VBI or overscan area, and the input terminal to a recording device or video device.

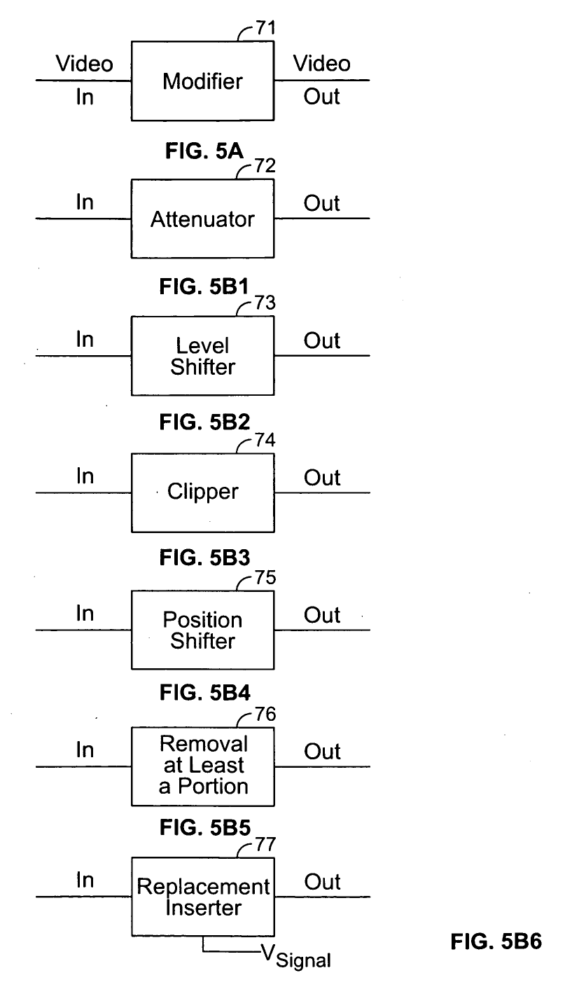

FIG. 5A illustrates a general example of a modifier apparatus 71 for a video signal, to improve the playability of the TV signal in an overscan area of a TV display. Modifier apparatus 71 may modify the incoming video signal in the digital and/or analog domain. Any combination of analog circuit(s), digital circuit(s), or software may implement at least a part of modifier apparatus 71. Modifier apparatus 71 may modify the video signal in any of the following ways, or in combinations thereof:
a) Add a signal to offset phase lock loop errors in an overscan area (e.g., to offset geometric errors on an overscan display). This may include adding at least one negative going pulse to a portion of the video signal.
b) Modify the position, pulse width, level, and/or amplitude of at least a portion of at least one selected negative going pulses that is in at least a portion of the VBI and/or at least a portion in the HBI, overscan area, and/or VBI. For example, this modification would improve during an overscan interval or area, any combination of viewing, geometric errors, phase lock loop oscillator errors, phase detector offset error, oscillator phase/frequency variation, and/or scanning (with) in overscan or blanking areas.
c) Modify the position, pulse width, level, and/or amplitude of a portion of at least one selected positive going pulses that is in a portion of the VBI and/or a portion in the HBI, overscan area, and/or the VBI. For example this modification would improve viewing in an overscan area.
d) Modify a level in a blanking interval and/or within an overscan area as to improve playability in an overscan area for a display device.

FIGS. 5B1 to 5B6 shows variants of the modifier apparatus 71 using various methods and associated apparatuses to modify a video signal in accordance with this disclosure. Attenuator 72 may attenuate at least one negative or positive going pulse within an overscan area. Such negative pulses may include equalizing pulses and/or any added negative going pulses, such as pseudo-sync pulses. For example, a positive going pulse may be an AGC (automatic gain control-added positive-going) pulse. For instance, in the case of the equalizing pulses, one or more equalizing pulses that occur in the middle of a TV scan line in an overscan area may be attenuated to improve playability in an overscan portion. For example, in the case of added negative going (pseudo-sync) pulses, at least a portion of one or more pseudo sync pulses may be attenuated or modified to improve playability in an overscan area (e.g., for a display showing blanking intervals or an overscan portion).

Similarly, for the example described above for attenuation, any combination of attenuation apparatus 72, level shifting apparatus 73, clipping apparatus 74, position shifting apparatus 75, removal apparatus 76, and/or replacing or adding apparatus 77, may be used as well to improve playability in an overscan area. Such methods and/or apparatuses as mentioned above may be included in modifier 71 in FIG. 5A, and such methods and/or apparatuses may modify in a static and/or dynamic (e.g., time varying) manner. Modifier 77 shows the Vsignal, which may be a waveform or signal that is inserted and/or added to a portion of the video signal or to at least a portion of one or more added pulses. Vsignal is an added or inserted signal to reduce (display) viewing effects in selected blanking or overscan intervals of a video signal. For example, Vsignal may be a negative going pulse that is added and or inserted (e.g., prior to a horizontal sync pulse) to reduce or cancel the offset error caused by the pulse E sync in FIG. 1C. See FIG. 1E as an example where a scan offset effect of signal RAH (e.g., similar to the E sync pulse of FIG. 1C), which is a negative pulse after a horizontal sync pulse, is at least partially cancelled out by signal JBH, which is a negative pulse before a horizontal sync pulse. Or, for example, Vsignal may lower a portion of the VBI and/or its vicinity to reduce darkening in an overscan area caused by positive going pulses. These effects may include darkening and/or geometric distortions of the displayed VBI and/or HBI.

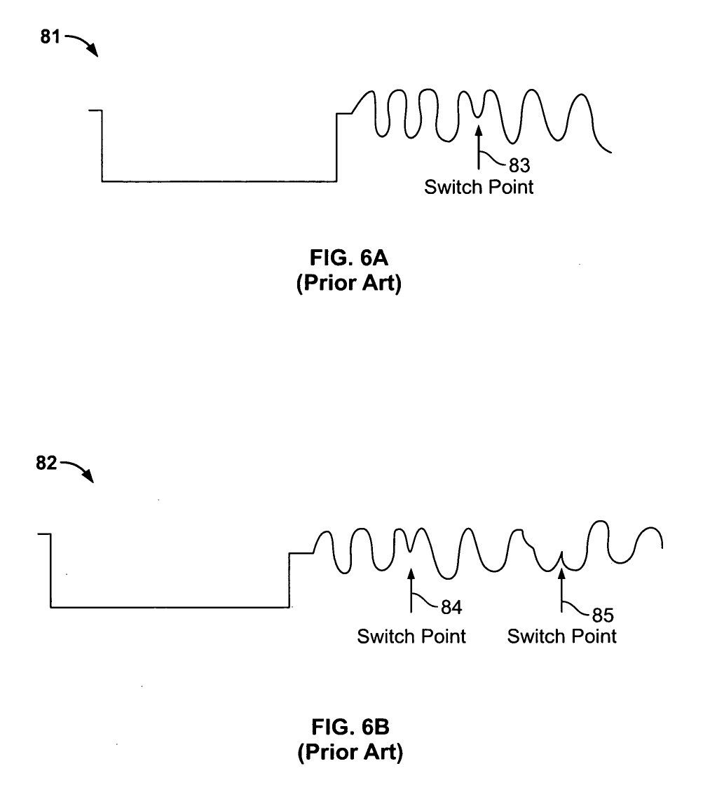

FIG. 6A (prior art) shows a waveform for an example of a modified video color burst 81, used conventionally for copy protection or content control with a single phase switch point 83, whereas FIG. 6B (prior art) shows a similar modified color burst 82, with phase switch points 84 and 85. The modified color burst of as illustrated in FIG. 6A and or 6B may be used in identifying a particular type of color processing system of a display.

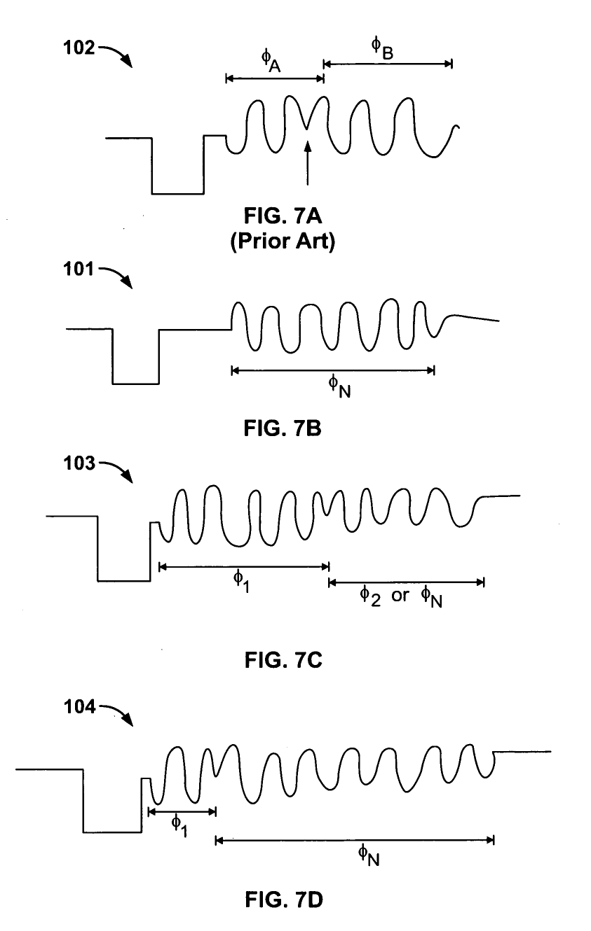

FIGS. 7A to 7D show various color burst waveforms. Color burst 101 denotes a normal (prior art) color burst with a normal phase φ_{N}. Waveform 102 shows a conventional color burst with a switch point that divides a series of cycles of phase φ_{A} and φ_{B}. Waveform 103 shows an example of a color burst wherein a switch point divides two phases φ₁ and φ₂ (e.g., where φ₂ may be a substantially normal phase φ_{N}). Waveforms 102 or 103 may be used as a copy protection signal on selected TV lines, or may be used to identify a color processing system in a display.

In general, a copy protection signal such as waveform 103 (or a colorstripe waveform) is provided in groups of a particular number of TV scan lines (such as 1, 2, 3, or 4 lines of color burst modification) per so many lines (such as 8, 9, 10, etc.) that would have a normal phase color burst such as waveform 101 as to form a version of a color stripe signal. For example in a set of 12 TV scan lines, 2 or 4 TV scan lines may include a waveform such as the waveform 102 of FIG. 7A that includes a phase modification, with the remaining 20 to 8 TV lines in the group having a “normal” signal (e.g., no phase modification of color burst) as shown at 101 of FIG. 7B. To increase effectiveness of a copy protection signal and or provide a new copy protection signal, modify at least one TV scan line in the color burst such as waveform 101 with a small amount of non-normal color burst subcarrier phase signal (e.g., 1 to 3 cycles or a selected number of cycles). In waveform 104, selected scan lines of waveform 101 are modified with phase φ₁. This modification of inserting or providing or adding a φ₁ signal to one or one TV scan lines (of previously) containing substantially normal phase provides a copy protection signal when another set of lines contains a colorstripe signal/waveform (such as waveform 103 or a generated colorstripe waveform). Note that any of the color burst signal modifications (such as waveform(s) 102, 103, and or 104) mentioned may be included in any TV lines in the active and or overscan areas for providing a copy protection signal.

One example is to fill or to provide a (e.g., substantial) number of TV scan lines that have color burst 101 with waveform 104 or the like, and or include another set of lines with a burst phase modifications such as 103 or a burst phase modifications wherein there are more cycles of non normal phase than the set of lines that has waveform 104.

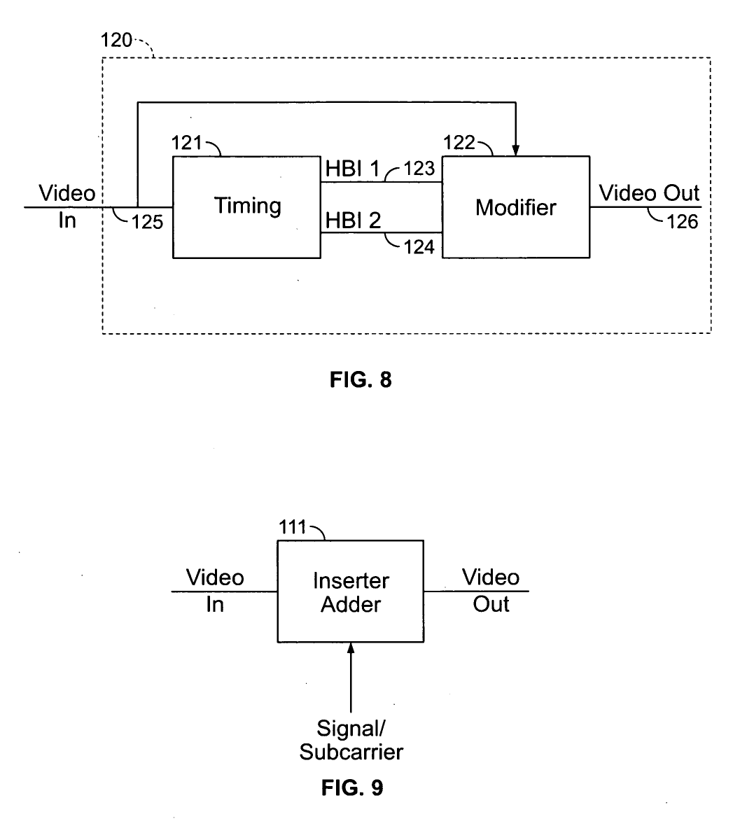

FIG. 8 shows an exemplary apparatus 120 to modify at least a portion of the HBI and/or its vicinity (for selected TV lines). A video input signal on terminal 125 is coupled to a timing circuit 121, which generates timing signals HBI1 (line 123) and/or HBI2 (line 124) which are coupled into a modifier circuit 122. Modifier circuit 122 then receives the video signal on terminal 125 and modifies at least a portion of the HBI and/or its vicinity to, for example, add or insert or provide a non-normal phase color burst in at least one TV scan line on terminal 126 (e.g., that has a substantially normal (phase) burst). FIG. 9 shows an exemplary modifier apparatus 111 in which a subcarrier signal is added or inserted to selected parts of a video input signal in at least one HBI area. For example, circuit 111 may add or provide or insert at least one cycle of non-normal phase subcarrier prior to (providing) a normal (phase) color burst envelope. Note that one can synthesize a copy protection signal having a selected number of lines with a split phase burst such as seen in FIG. 6A or 6B or in waveform 103 (where the color burst envelope may contain extra cycles as compared to a standard color burst), and then add or provide at least a portion of a non-normal phase to at least one line not containing the split burst color burst (or a colorstripe signal) such as φ1 in FIG. 7D. Although the examples of 102, 103, and 104 show two zones of phase, more than two zones may be provided to synthesize a copy protection signal.

A new colorstripe (e.g., copy protection) signal (which may be combined with another video copy protection signal that may include any combination of pseudo sync, AGC pulses, modified front and or back porch level, added pulses in an overscan area, which may include a portion of an active video line) may include a plurality of cycles of normal and non-normal phase subcarrier cycles in a horizontal blanking interval of one set of selected lines, and in another set of selected lines containing at least a portion of a non-normal phase subcarrier cycle along with many cycles of normal phase subcarrier. For example, in a copy protection signal one set of TV lines may produce 1 to 3 cycles of non normal phase subcarrier followed by 6 to 12 cycles of normal phase subcarrier in an HBI, while another set of TV lines may produce 4 to 7 cycles of non normal phase followed by 4 to 7 cycles of normal phase subcarrier in an HBI. Of course other numbers may be used for cycles of normal and or non normal phase subcarrier. In another example, there are two (or more) sets of TV lines containing color burst (phase) modifications. One set of TV lines has fewer cycle(s) of non normal phase subcarrier in a back porch area or HBI than another set of TV lines. And of course, any of these burst modifications may include any added pulses, and or HBI modifications in a front and or back porch region.

It should be also noted that by providing (e.g., at least, some, or all) lines with some phase modification for a new color stripe signal, (e.g., one set of TV lines having more cycles of phase modification than another set of TV lines), the effectiveness of the colorstripe process is increased. For example, TV systems (e.g., video recorders) using comb filters or the like average the color signal between successive TV lines. It has been found for instance, a two line color stripe process is much less effective compared to a 4 line color stripe process with some recorders with certain comb filters. Part of the reason is that the two color stripe signal is smeared or averaged out by comb filters, which utilize line to line averaging. For example, averaging between a TV line with signal 101 and another TV line with signal 103 will cause the first one or two φ1 cycles of signal 103 to attenuate because in 101, the burst cycles do not start as immediately as the burst cycles of signal 103. The average amplitude from signal 101 to 103 for the first cycle period immediately following the horizontal sync pulse is about 50%. Thus, providing or replacing (one or more TV lines of) the generally non-modified color burst signals of 101 with 104, will cause less (copy protection effect) attenuation (or consequently more copy protection effectiveness) through a comb filter from waveforms 104 to 103 (e.g., resulting or providing a more effective colorstripe signal for a 1 or 2 or 3 or 4 line copy protection signal). This new color stripe (copy protection) signal, which is more effective with a recorder or device utilizing a comb filter, may also be used for identifying a particular type of signal processing used in TV displays (e.g., see below).

One embodiment provides a method for identifying whether a TV display incorporates a comb filter or a traditional analog filter. The comb filter normally uses delay lines to subtract or add one TV scan line to another (successive) scan line. In so doing, with a test signal or certain program video signals, an indication of a comb filter is an artifact known as “hanging dots” as observed in the active picture area (from one scan line to another line). A traditional analog filter does not result in these hanging dots. These hanging dots are not readily observed with a video program since the video signal tends to change from scene to scene, and not every scene may have sufficient color information to allow a viewer to observe the hanging dots when viewed normally on a standard TV set.

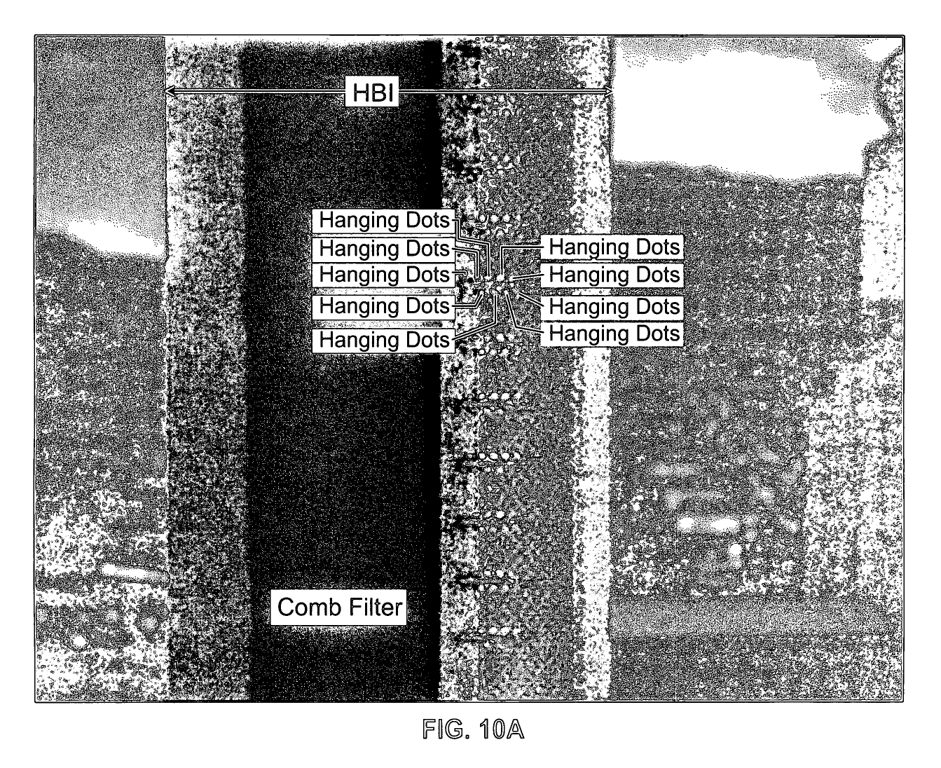

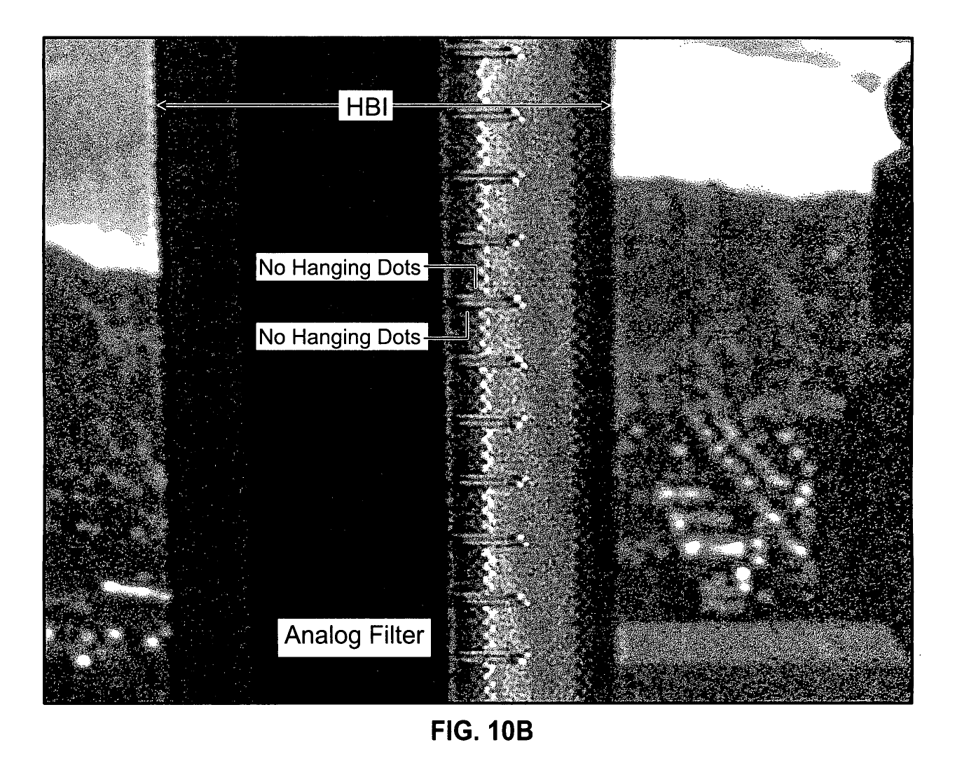

Therefore, a new use for adding a colorstripe signal, which may include at least one cycle of subcarrier different from a substantially normal phased color burst signal, may be provided in at least one scan line in the HBI (horizontal blanking interval). This color burst modification may take the place of at least one cycle of a substantially normal phase color burst, and or may be provided in another area in the HBI wherein the input color burst may not reside. For example, modifying a video signal with a split phase color burst envelope for 2 to 4 scan lines followed by at least one line of substantially normal color burst signal, will readily show hanging dots in an HBI or overscan area (e.g., as displayed on a monitor that has an H and or H-V delay function), which identifies a TV display with a comb filter. If there are no hanging dots displayed in the HBI or overscan area, then the TV display is identified as having an analog filter. Thus a new use of a colorstripe copy protection signal is for a method and apparatus that allows identification of a particular type of filter used in the color processing of video signals in a display (e.g., by viewing an overscan area). Of course, modifying the phase and or amplitude of the color-stripe signal will reduce the capability of identifying the type of color processing system (comb filter or traditional analog chroma filter) in a TV display that has horizontal and or vertical delay display feature. See FIG. 10A depicting hanging dots in an overscan area (e.g., via a display that has an H-V delay function or feature) from a TV monitor with a comb filter. The horizontal (blue in color on the actual display) stripes are caused by the conventional colorstripe burst modification in an overscan area. A portion just to the right of the stripes (which is green in color in the actual display) represents normal color burst phase. Note in FIG. 10A that the color stripe signal is two scan lines in nature, but with a comb filter only one (blue) color stripe scan line is clearly displayed in an overscan area. With the two scan line color stripe signal displayed in an overscan area by a TV set with an analog filter, the two (blue) horizontal colorstripe scan lines are clearly seen, and without showing hanging dots, as depicted in FIG. 10B.

In another embodiment, the use of added pulse(s) or signal(s) in a portion of the video signal may be used for generating a distortion when a blanking interval or overscan portion is displayed. For example, one or more pseudo-sync pulses may be used in causing a display error in a TV set that displays the overscan area. In another example, a positive going pulse/signal may be used for darkening a displayed overscan area. Or, a modified back porch level may darken (e.g., cause a raised back porch interval) or brighten (e.g., lowered back porch interval) of a blanking interval or overscan area when displayed.

It should be noted that any apparatus or method described here may include any combination of detector or reader that provides a signal indicative of the presence of any copy protection signal (e.g., pseudo-sync pulses, sync amplitude, sync pulse-width, and or sync position modifications, back and or front porch modifications, added positive going pulses, color burst phase, frequency, and or amplitude modifications) and/or copy protection information signal (e.g., APS bit(s), analog copy protection system, CGMS, CGMS-A, CGMS-D, HDCP, control bit(s), and/or a data signal).

Also, any method or apparatus described here may be implemented in the analog, digital, or software domain or combinations thereof. The video signals mentioned in any part of this disclosure may be any standard (e.g., analog and or digital) television or video display signal. Any such apparatus and or method described may include scaling such as time and/or frequency scaling or translation.

This disclosure is illustrative but not limiting; further modifications will be apparent to one skilled in the art in light of this disclosure and are intended to fall within the scope of the appended claims.

I claim:

1. A method comprising the acts of:
providing a video signal to a video display device which displays an overscan portion and an active portion of a video image associated with the video signal; and
modifying a portion of the video signal in a blanking interval thereof;
wherein as a result of the modification the displayed overscan portion exhibits improved viewability.

2. The method of claim 1, wherein the portion of the video signal in the blanking interval includes equalizing pulses, and the modifying includes modifying at least one equalizing pulse.

3. The method of claim 2, wherein the modifying includes at least one of removing, altering a duration of, altering a position of, or altering an amplitude of at least one equalizing pulse.

4. The method of claim 1, wherein the portion of the video signal in the vertical blanking interval includes at least one added pulse not present in a standard television signal, and the modifying includes modifying the added pulse.

5. The method of claim 4, wherein the added pulse is positive going or negative going with regard to the video signal.

6. The method of claim 4, wherein the modifying includes at least one of removing, altering a duration of, altering a position of, or altering an amplitude of at least one added pulse.

7. The method of claim 4, wherein the added pulse is present in a back porch region of a horizontal scan line in the vertical blanking interval.

8. The method of claim 1, wherein in the absence of the modifying, the displayed overscan portion exhibits distortion.

9. The method of claim 5, wherein the presence of the added pulses in the absence of the modification causes a voltage clamping error in the displayed overscan portion, and wherein the modification of the added pulses reduces the voltage clamping error, thereby improving viewability of the displayed overscan portion.

10. The method of claim 1, wherein the video display device is one of a television receiver, television monitor, video monitor, cross pulse monitor, or computer display.

11. The method of claim 1, wherein the modifying includes adding or inserting at least one negative going pulse prior to or after one or more horizontal sync pulses.

12. The method of claim 1, wherein the video signal includes a positive or negative level in a back porch region in selected horizontal scan lines in the overscan portion which causes a luminance clamp error when the video signal is displayed in the overscan portion, and wherein the video signal is modified to provide a reduced luminance clamp error in the overscan portion.

13. Apparatus for modifying a video signal, adapted to be coupled to provide the modified video signal to a video display device which displays an overscan portion and an active portion of a video image associated with the video signal, the apparatus comprising:
an input port for receiving the video signal;
an output port adapted to be coupled to the video display device; and
circuitry coupled between the input and output ports which modifies the video signal in a blanking interval thereof;
wherein as a result of the modification the overscan portion of the video signal when displayed on the video display device exhibits improved viewability in the overscan portion.

14. The apparatus of claim 13, wherein the portion of the video signal in the blanking interval includes equalizing pulses, and the modifying includes modifying at least one equalizing pulse.

15. The apparatus of claim 14, wherein the modifying includes at least one of removing, altering a duration of, altering a position of, or altering an amplitude of at least one equalizing pulse.

16. The apparatus of claim 13, wherein the portion of the video signal in the vertical blanking interval includes at least one added pulse not present in a standard television signal, and the modifying includes modifying the added pulse.

17. The apparatus of claim 16, wherein the added pulse is positive going or negative going with regard to the video signal.

18. The apparatus of claim 16, wherein the modifying includes at least one of removing, altering a duration of, altering a position of, or altering an amplitude of at least one added pulse.

19. The apparatus of claim 16, wherein the added pulse is present in a back porch region of a horizontal scan line in the vertical blanking interval or in an overscan area.

20. The apparatus of claim 13, wherein in the absence of the modifying, the displayed overscan portion exhibits distortion.

21. The apparatus of claim 17, wherein the presence of the added pulses in the absence of the modification causes a voltage clamping error in the displayed overscan portion, and wherein the modification of the added pulses reduces the voltage clamping error, thereby improving viewability of the displayed overscan portion.

22. The apparatus of claim 13, wherein the video display device is one of a television receiver, television monitor, video monitor, cross pulse monitor, or computer display.

23. The apparatus of claim 13, wherein the modifying includes adding or inserting at least one negative going pulse prior to or following one or more horizontal sync pulses.

24. A method of synthesizing a video copy protection signal, comprising the acts of:
providing a video signal having a set of scan lines having color burst cycles of non-normal phase in a horizontal blanking interval; and
providing another set of scan lines in the video signal containing fewer cycles of non-normal phase in a horizontal blanking interval than the first set, wherein the synthesis of the video copy protection signal provides a more effective color stripe video copy protection signal.

25. A method of identifying a type of color processing system in a television or video display, comprising the acts of:
providing to the display a video signal having at least one cycle of incorrect phase in a color burst portion of one or more scan lines of the video signal; and
observing a color burst portion of an overscan area of the display when the video signal is displayed, wherein an observed attenuation or hanging dots in the color burst portion denotes a comb filter color processing system.

26. A method of modifying a video signal to have a modified color burst therein, the method comprising the acts of:
providing in the video signal a color burst that includes at least one cycle of incorrect phase for a selected set of scan lines of the video signal; and
wherein the modified color burst allows identification of a color processing system of a television or video display when at least a portion of the color burst area is displayed thereon.
